(19) United States
(12) Patent Application Publication
(10) Pub. No.: US 2025/0203389 A1
(43) Pub. Date: Jun. 19, 2025

(54) MULTI-AP COORDINATION GROUP (MAPC-CG) OPTIMIZATION USING MACHINE LEARNING

(71) Applicant: Cisco Technology, Inc., San Jose, CA (US)

(72) Inventors: Malcolm M. SMITH, Richardson, TX (US); Brian D. HART, Sunnyvale, CA (US); Indermeet S. GANDHI, San Jose, CA (US)

(21) Appl. No.: 18/592,348

(22) Filed: Feb. 29, 2024

Related U.S. Application Data
(60) Provisional application No. 63/612,336, filed on Dec. 19, 2023.

(51) Int. Cl. H04W 16/22; H04W 24/02

(52) U.S. Cl. CPC H04W 16/22; H04W 24/02

(57) ABSTRACT

The present disclosure provides techniques for optimizing multi-AP coordination group (MAPC-CG) formation. A reinforcement learning (RL) model is used to select a plurality of Coordination Groups (CGs) for a network device to join in a network environment. A plurality of performance data sets are collected for the network device, where each respective performance data set corresponds to a respective CG selection by the network device. One or more parameters for the RL model are predicted using a machine learning (ML) model, where the ML model is trained based on the plurality of performance data sets. The RL model to select one or more CGs, from the plurality of CGs, is executed based on the predicted one or more parameters.

### CROSS-REFERENCE TO RELATED APPLICATIONS

This application claims benefit of co-pending U.S. provisional patent application Ser. No. 63/612,336 filed Dec. 19, 2023. The aforementioned related patent application is herein incorporated by reference in its entirety.

### TECHNICAL FIELD

Embodiments presented in this disclosure generally relate to wireless communication. More specifically, embodiments disclosed herein relate to the utilization of machine learning (ML) techniques to optimize the formation of coordination groups (CGs) in multi-AP wireless network environments.

### BACKGROUND

In Wi-Fi 8 and beyond, Multi-AP Coordination (MAPC) mechanisms are used to improve spatial reuse efficiency in wireless networks by having multiple access points (APs) coordinate their transmissions. The coordination mechanisms involve deciding when and how these APs transmit data to optimize factors such as latency (delay in data transmission) and capacity (how much data can be transmitted).

An important aspect of MAPC is the formation of a coordination group (CG). The process involves making real-time decisions (e.g., within 10s of milliseconds) about which APs should be grouped into a CG and which form of MAPC to use (e.g., using different spaces, times, frequencies, or tones for transmission). Challenges arise in grouping CGs due to the limitations of the current Radio Resource Management (RRM) system.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts an example wireless network environment that supports multi-AP coordination (MAPC) for medium resource access, according to some embodiments of the present disclosure.

FIG. 2 depicts an example reinforcement learning (RL) model, according to some embodiments of the present disclosure.

FIG. 3 depicts an example workflow for supervised machine learning (ML) training and prediction, using access delays as labels, according to some embodiments of the present disclosure.

FIG. 4 depicts an example workflow for supervised machine learning (ML) training and prediction, using total timeslots as labels, according to some embodiments of the present disclosure.

FIG. 5 depicts an example method for optimizing coordination group (CG) formation in multi-AP networks using machine learning (ML) models, according to some embodiments of the present disclosure.

FIG. 6 is a flow diagram depicting an ML-driven framework for multi-AP coordination group (MAPC-CG) formation and optimization, according to some embodiments of the present disclosure.

FIG. 7 depicts an example computing device configured to perform various aspects of the present disclosure, according to one embodiment.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure provides a method, including using a reinforcement learning (RL) model to select a plurality of Coordination Groups (CGs) for a network device to join in a network environment, collecting a plurality of performance data sets for the network device, where each respective performance data set corresponds to a respective CG selection by the network device, predicting one or more parameters for the RL model using a machine learning (ML) model, where the ML model is trained based on the plurality of performance data sets, and executing the RL model to select one or more CGs, from the plurality of CGs, based on the predicted one or more parameters.

Other embodiments in this disclosure provide one or more non-transitory computer-readable media containing, in any combination, computer program code that, when executed by operation of a computer system, performs operations in accordance with one or more of the above methods, as well as systems comprising one or more computer processors and one or more memories collectively containing one or more programs, which, when executed by the one or more computer processors, perform operations in accordance with one or more of the above methods.

### Example Embodiments

The present disclosure provides techniques designed for forming Multi-AP Coordination Groups (MAPC CGs) in wireless networks using a combination of reinforcement learning (RL) and supervised machine learning (ML) models.

Conventional Radio Resources Management (RRM) systems manage network resources (like channel size, position, and transmission power) based on long-term statistics, such as signal strength (e.g., received signal strength indicator (RSSI), signal-to-noise (SNR)) collected over extended periods, which is too slow for the quick decision-making relied upon in MAPC. Additionally, RRM does not consider the near or medium-term intentions of APs regarding their spatial or temporal use plans, which limits its effectiveness in guiding CG formation for MAPC. Furthermore, while APs currently collect real-time metrics for their own Basic Service Sets (BSS) and use them for scheduling purposes, they neglect valuable data from Overlapping BSS (OBSS), such as RSSI from clients in neighboring BSSs. This oversight may cause APs to form CGs that inadvertently cause interference with clients in neighboring BSSs, leading to reduced network efficiency and increased congestion.

Embodiments of the present disclosure introduce a method for CG formation, utilizing a combination of RL and supervised ML models to optimize network resource utilization in multi-AP wireless network environments. Embodiments of the present disclosure enhance CG formation by intelligently adapting to network conditions, to ensure efficient management and allocation of network resources for improved performance. In some embodiments of the present disclosure, an RL model may be implemented to enable an AP (as the RL agent) to trial different potential CGs rapidly (e.g., within a single transmission opportunity (TXOP) or across a small number of TXOPs, such as several tens of TXOPs). The RL follows a greedy policy to join every CG with which the agent AP has sufficient signal strength (e.g., RSSI, SNR) to ensure reliable communication. The greedy policy is designed to maximize the network resource (e.g., TXOPs) that the agent AP can obtain. As the RL model operates, various performance metrics may be collected, for the purpose of learning the impact of the AP's CG selections and leadership decisions on network efficiency. The collected performance metrics may include the RSSI/SNR values, the number of CGs joined, the access delays, and the outcomes of resource allocation (e.g., the number of TXOPs and/or Resource Units (RUS) assigned to the agent AP). In some embodiments, the collected performance metrics may be used as training datasets for supervised ML, to predict optimal (or at least improved) RL hyperparameters. In some embodiments, during the supervised ML training, the model may use the collected performance metrics (like RSSI threshold) as input features, and the measured access delays and/or resources allocation outcomes (e.g., the number of TXOPs) as target outputs. After training, the ML model may be used to predict the optimal (or at least improved) hyperparameters for the RL model, such as the maximum number of CGs that the agent AP can join, any specific CGs to avoid, the frequency of joining or opting out of CGs, and the RSSI/SNR threshold for CG participation. Once determined, these hyperparameters may then be applied to the RL model. The application serves to refine and enhance the decision-making process specifically for CG formation (e.g., enabling the agent AP to join proper CGs), leading to more efficient and effective network resource management.

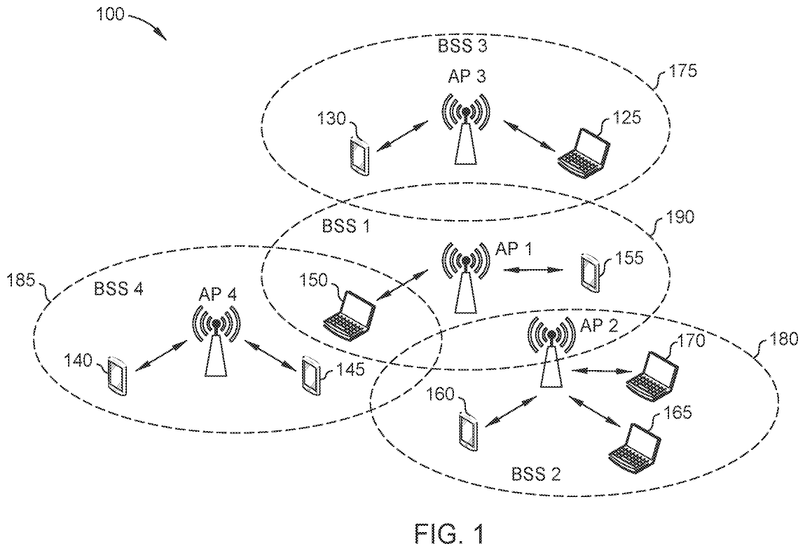

FIG. 1 depicts an example wireless network environment 100 that supports multi-AP coordination (MAPC) for medium resource access, according to some embodiments of the present disclosure.

This example environment 100 includes four Basic Service Sets (BSSs) (BSS 1, BSS 2, BSS 3, and BSS 4). Each BSS includes one access point (AP) and several station devices (STAs) as members. For example, AP 1 and its associated STAs 150 and 155 form BSS 1. AP 2 and its associated STAs 160, 165 and 170 form BSS 2. AP 3 and its associated STAs 125 and 130 form BSS 2. AP 4 and its associated STAs 140 and 145 form BSS 4. Each AP has a signal coverage area, such as AP 1 having a signal coverage 190, AP 2 having a signal coverage 180, AP3 having a signal coverage 175, and AP4 having a signal coverage 185. In some embodiments, AP 1 may communicate directly with AP 2, AP 3 and AP 4 to form CGs if they are within signal range of each other. In some embodiments, AP 1 may communicate with other APs via a wired or wireless backbone connection.

The illustrated environment 100 comprising four APs suggests the potential for forming up to seven different CGs involving AP 1. These include CG 1 comprising AP 1 and AP 2, CG 2 comprising AP 1 and AP 3, CG 3 comprising AP 1 and AP 4, CG 4 comprising AP 1, AP 2 and AP 3, CG 5 comprising AP 1, AP 2 and AP 4, CG 6 comprising AP 1, AP 3 and AP 4, and CG 7 comprising AP 1, AP 2, AP 3 and AP 4. The actual formation of these CGs will depend on the specific spatial arrangement of the APs, as well as whether the signal strength between AP 1 and other APs (or client devices) meets the established thresholds (e.g., RSSI/SNR thresholds) for forming a CG.

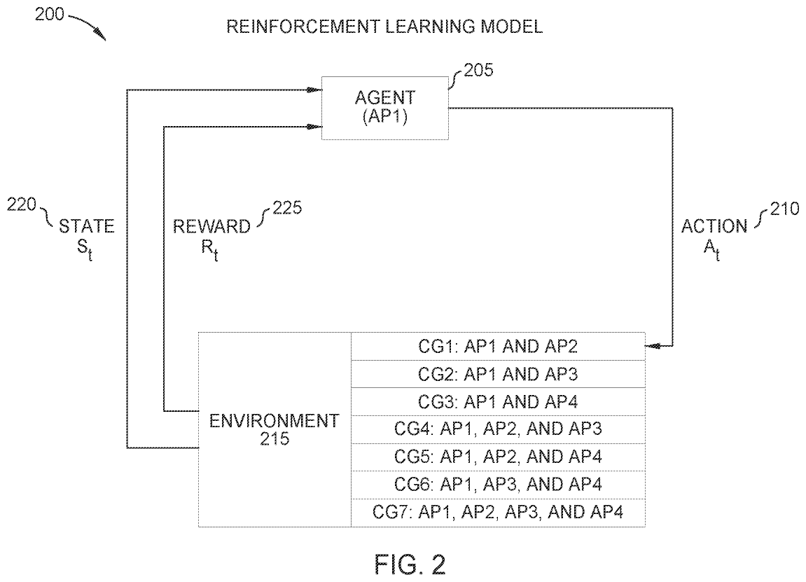

In some embodiments, within the illustrated network environment 100, a reinforcement learning (RL) model may be utilized, with AP 1 acting as the agent, to quickly trial all different potential CGs. The RL model may follow a greedy policy, which allows the agent (AP 1) to join every possible CG (up to 7) as long as the signal strength between AP 1 and other APs (or client devices) in the CG meets or exceeds a defined threshold. This approach enables AP 1 to quickly assess the viability and benefits of participating in various CGs, based on real-time network conditions and performance feedback (e.g., access delays, allocated network resources). More details regarding the RL model are discussed below with reference to FIG. 2.

FIG. 2 depicts an example RL model 200, according to some embodiments of the present disclosure.

The depicted RL model 200 is configured to quickly evaluate all possible CGs within a defined wireless network environment (e.g., 100 of FIG. 1, which includes four BSSs). In some embodiments, the evaluation may occur within a timeframe of a single transmission opportunity (TXOP) or extend over several tens of TXOPs (e.g., for a few 100s of milliseconds).

Within the depicted RL model 200, the AP 1 (which may correspond to the AP 1 of FIG. 1) acts as the agent 205, and the environment 215 (which may correspond to the environment 100 of FIG. 1, which includes four BSSs, each with an AP) includes up to seven potential CGs that the AP 1 can join. The action 210 taken by agent 205 consists of binary decisions to join or not join each CG. For example, in some embodiments, the agent AP 1 (205) may take an initial action (Aₜ₌₁) to join CG 1, leading to an updated state 220 (Sₜ₌₁). The new state 220 (Sₜ₌₁) reflects the new membership, with AP 1 now being part of CG 1. Along with the new state 220 (Sₜ₌₁), network performance metrics are measured and collected. These metrics may include the signal strength (e.g., RSSI, SNR) measured between AP 1 and other members of CGs (like AP 2 and/or its associated STAs), access delays, and allocated network resources for AP 1 through MAPC (e.g., the total timeslots, the total number of TXOPs or RUs). A reward 225 (Rₜ₌₁) is then assigned based on the detected signal strength. When the signal strength between AP 1 and other members of CG 1 meets or exceeds a predefined threshold (e.g., RSSI threshold, SNR threshold), a positive reward 225 (Rₜ₌₁) is assigned. Alternatively, a negative or no reward 225 (Rₜ₌₁) is allocated when the signal strength falls below the threshold. In some embodiments, such as when the CG 1 includes more than one member (like AP 2 and AP 3), the signal strength evaluated for reward purposes (Rₜ₌₁) may be based on the average, maximum, minimum, or median of the detected signal strengths between AP 1 and the other APs (like AP 2 and AP 3).

In some embodiments, subsequent to joining CG 1, AP 1 may proceed to test CG 2 through the action 210 (Aₜ₌₂), which updates the state 220 to Sₜ₌₂. The new state 220 (Sₜ₌₂) reflects AP 1's participation in CG 2. Any changes in performance metrics, such as the signal strength, the access delays, and/or the network resource allocations, as a result of joining CG 2, may be detected and recorded. The process continues with AP 1 taking further actions 210, like joining CG 3 (Aₜ₌₃), and so forth, until all seven possible CGs have been examined independently. With each new action 210, the state 220 is updated to reflect the changes in CG memberships. In some embodiments, based on the rewards from the independent evaluations, the RL model may determine which CGs the agent AP (AP 1) should join. For example, if both CG 1 and CG 2 independently show positive rewards, the model identifies these CGs as suitable for AP 1 to join. The RL model may then rerun to assess the cumulative impact of joining these CGs simultaneously, particularly focusing on access delay and resource allocation. The cumulative assessment allows for determining the overall impact on network performance when AP 1 joins multiple CGs.

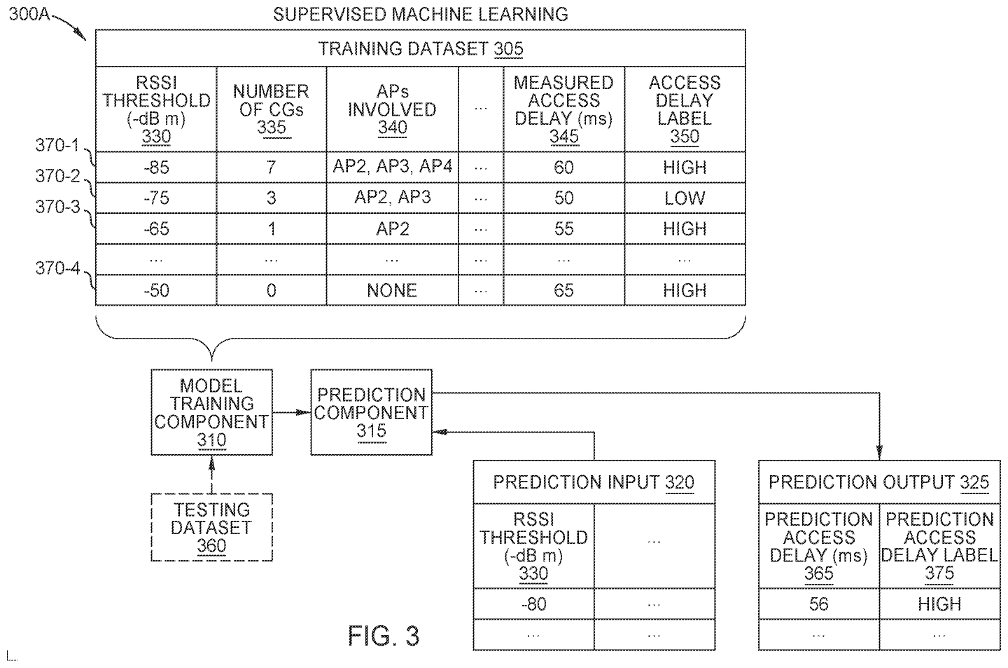

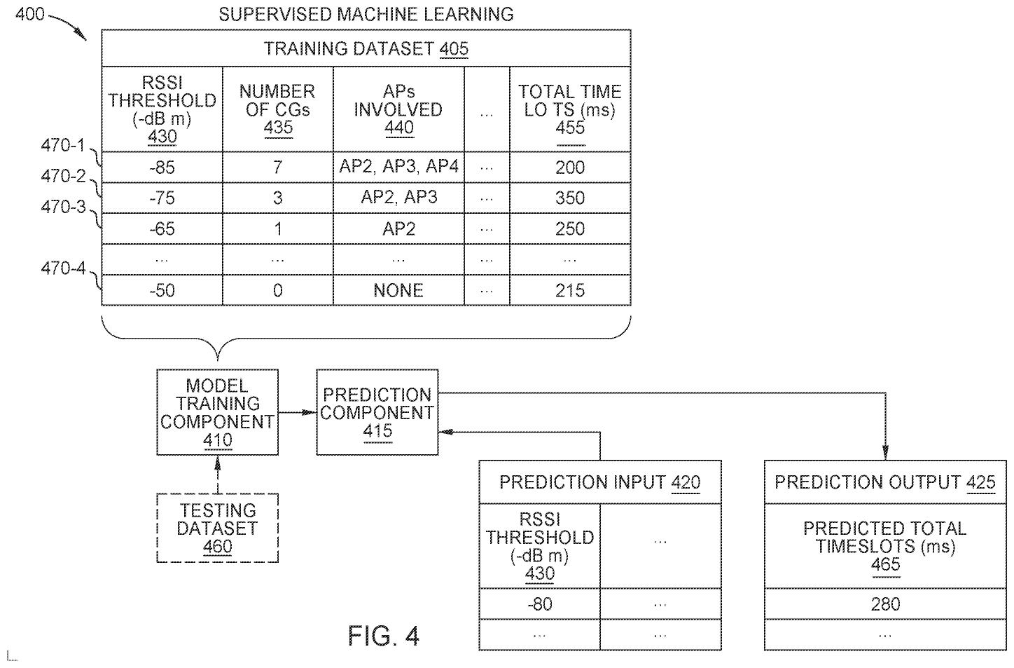

In some embodiments, a greedy policy may be followed by the RL model 200, which guides the agent AP 1 to join any CG where the signal strength condition is met and/or to volunteer for leadership (for the purpose of securing the earliest timeslots in a future TXOP). The greedy approach may lead AP 1 to join as many CGs as possible, as long as the signal strength meets or exceeds defined thresholds (e.g., RSSI/SNR thresholds). The greedy policy may maximize (or at least optimize) the immediate gains in signal quality and network resource allocations. However, this policy does not consider the long-term implications or the broader impact on the overall network performance. For example, joining too many CGs may lead to increased coordination overhead, particularly in congested network environments. Being part of multiple CGs means that the agent AP (AP 1) has to participate in more coordinated activities, such as TXOP allocation negotiations, which may introduce significant overhead and result in longer wait times for TXOPs. Furthermore, the complexity of managing interference and prioritization increases with the number of CGs AP 1 joins. Each CG may have different policies or requirements for TXOP allocation. Balancing these elements may become complex, especially if there are conflicting interests or interference concerns among the CGs. The increased complexity in interference management may extend the decision-making process, and potentially cause delays in accessing TXOPs. Therefore, indiscriminate participation of multiple CGs (and/or volunteering for leadership), driven by a greedy RL model, may inadvertently compromise the AP 1's long-term efficiency and the overall network performance. To address this, a supervised machine learning (ML) model may be utilized to fine-tune the hyperparameters of the RL model. The adjustments are designed to make the RL model less “greedy,” guiding the agent AP (AP 1) to select CGs considering both immediate network benefits and long-term impacts on efficiency and network performance. More details regarding the supervised ML are discussed below with reference to FIGS. 3 and 4.

FIG. 3 depicts an example workflow 300 for supervised machine learning (ML) training and prediction, using access delays as labels, according to some embodiments of the present disclosure.

In the illustrated example, a training dataset 305 is prepared for supervised model training. The training dataset 305 includes five variables: RSSI threshold 330, number of CGs 335, APs involved 340, measured access delay 345, and access delay label 350. In some embodiments, the RSSI threshold 355 may refer to the signal strength thresholds set by a RL (e.g., 200 of FIG. 2), determining the minimum acceptable signal quality for the agent (e.g., AP 1 of FIGS. 1 and 2) to join a CG. The number of CGs 335 may indicate the total number of CGs that the agent (AP 1) joined. The APs involved 340 may list the specific APs that are members of the CGs along with AP 1. The measured access delay 345 may refer to the latency experienced by the agent (AP 1) in transmitting data to its associated STAs (e.g., 150 of FIG. 1). In some embodiments, the access delay label 350 may categorize the delay into two classes (“high” and “low”) based on predefined QoS requirements for different types of traffic.

The training dataset 305 captures the impact of different RSSI thresholds on the CG formation and the corresponding access delays experienced by AP 1, which acts as the agent in a greedy RL model (e.g., 200 of FIG. 2). Each row represents an individual data sample 370, corresponding to a unique network configuration as determined by the RL model under a specific RSSI threshold setting. For example, the first row 370-1 in the training dataset 305 sets the RSSI threshold 330 at −85 dBm. Under this threshold, the RL model is configured to have AP 1 (the agent) join any CG where the signal strength between AP 1 and other members in the CG meets or exceeds −85 dBm. As shown, 7 CGs pass the threshold, and the APs involved in these 7 CGs include AP 2, AP 3, and AP 4 (as depicted in FIG. 1). When AP 1 seeks to transmit data, like to one of its associated STAs (e.g., 150 of FIG. 1), AP 1 must engage in coordination with these APs to minimize interference within the network. A measured access delay 345 of 60 milliseconds (ms) is recorded, implying that the AP 1 waits 60 milliseconds before it can access the medium for transmission. The 60 ms access delay is classified as “High,” and the delay is likely caused by the complexity of coordinating TXOPs among the 7 CGs.

The second data sample 370-2 in the training dataset 305 shows that, when the RSSI threshold 330 is set to −75 dBm, the greedy RL model enables AP 1 to join 3 CGs. The APs involved in these groups are AP 2 and AP 3 (as depicted in FIG. 1). The reduced number of CGs, compared to the first data sample 370-1, suggests a higher signal strength requirement for CG formation. In some embodiments, the exclusion of CGs involving AP 4 may indicate that the signal strength between AP 1 and AP 4 (or its associated client devices) falls below the −75 dBm threshold. In such configurations, AP 1, while still coordinating with AP 2 and AP 3, does not have a sufficiently strong signal to effectively communicate with AP 4 or the STAs associated with it (e.g., 140 and 145 of FIG. 1), under the stricter CG formation rule set by the higher RSSI threshold. As illustrated in the training dataset 305, the measured access delay 345 within the second data sample 370-2 is 50 ms, which is categorized as “Low.” This suggests an improvement in network performance, possibly due to more effective and streamlined coordination between AP 1 and fewer APs, which results in reduced access delay.

In contrast, the third data sample 370-3 with the RSSI threshold 330 of −65 dBm shows AP 1 joining only 1 CG, which includes AP 2 (as depicted in FIG. 1). The measured access delay 345 for AP 1 is increased to 55 ms and is classified as “High.” The increases in access delay may indicate that, while fewer CGs may simplify the network coordination (e.g., by reducing coordination overhead), further reductions in CG participation may lead to inefficiencies. The single CG that AP 1 is part of may not have the most favorable conditions for transmission, due to factors like interference, traffic congestion, or suboptimal channel quality within the particular CG. Furthermore, being part of only one CG may limit AP 1's ability to access the broader range of TXOPs that often come along with being part of multiple CGs. AP 1 may lose some spatial or temporal reuse opportunities, leading to increased waiting times for a suitable TXOP and, as a result, a higher access delay.

The fourth data sample 370-4, with an RSSI threshold of −50 dBm, results in AP 1 not joining any CGs, as no APs are involved. The measured access delay increases to 65 milliseconds and is categorized as “High.” In this configuration, AP 1 has to compete for medium access without the benefits of coordination provided by CGs, which, therefore, leads to potential contention with other non-coordinated APs and devices in the network.

The training dataset 305 effectively captures the data patterns between different RSSI thresholds on CG formation and the resulting access delays experienced by AP 1. As illustrated, the training dataset 305, once compiled and aggregated, is transmitted to the component 310 for supervised model training. The model is specifically trained to predict access delay based on a received RSSI threshold (which is one hyperparameter in defining the RL model). During the training process, the first three variables in the dataset—RSSI threshold 330, number of CGs 335, and the APs involved 340—are utilized as input features. These features provide the model with information about the network environment under various CG configurations. The last two variables—measured access delay 345 and access delay label 350—are used as target outputs, each serving a different purpose based on the type of ML model being trained. In some embodiments, for training a regression model that is configured to predict the actual measured access delay (e.g., delay in milliseconds), the measured access delay 345 is used as the continuous target output. This allows the ML model to predict the specific delay times that may be experienced under different network conditions (e.g., under different RSSI thresholds). For a classification model, in some embodiments, the measured access delay 345 may be categorized into low and high classes using a predetermined threshold. In some embodiments, the threshold may be determined based on quality of service (QOS) requirements for different traffic types. For example, a threshold of 50 milliseconds may be set for voice data, with delays above the threshold categorized as “High” and those below it as “Low.” The access delay label 350, derived from this categorization, is then utilized as the categorical target output for the classification ML model.

The illustrated access delay label 350 that categorizes delay times into two categories (“High” and “Low”) is depicted for conceptual clarity. In some embodiments, the classification of access delays may be more complex, with any number of classes used (e.g., “High,” “Medium,” “Low”) depending on the system's requirements.

In some embodiments, during the model training process, various algorithms may be used to predict access delays based on the RSSI threshold and other relevant features. The selection of algorithm may depend on the characteristics of the data and the desired outcomes (regression or classification). For a regression model trained to predict measured access delays, algorithms such as linear regression, decision trees, random forest regression, neural networks, and others may be utilized. For a classification model that categorizes access delay as “Low” and “High,” algorithms suitable for classification tasks can be used. These may include, but are not limited to, logistic regression, support vector machines (SVM), decision tree classifiers, and random forest classifiers, among others.

In some embodiments, after the training is complete, a testing dataset 360 may be applied to test the accuracy and effectiveness of the trained model. The testing dataset 360, which includes unseen and labeled data samples, is different from the training dataset 305, and serves to evaluate how well the model fits with new data, beyond what it was trained on. The performance of the model during the testing phase may be measured using various metrics. For classification models, the metrics may include accuracy, precision, recalls, and F1-score. For regression models, metrics like mean absolute error (MAE) and mean squared error (MSE) may be used. If the model's performance on the testing dataset is sufficiently accurate and effective, the model may then be provided to the component 315 for inference, such as predicting access delays in a wireless network based on RSSI thresholds and other relevant variables. If the model's performance on the testing dataset is unacceptable (e.g., not being accurate enough or requiring excessive computation time), further tuning may be required. This may involve using additional training data or reassessing and possibly modifying the selected algorithms.

In the illustration, after the model is deployed for inference in the prediction component 315, the model receives new input data 320 that includes RSSI threshold 330 and other input variables. As illustrated, the new input 320 includes a data sample where the RSSI threshold 330 is set at −80 dBm. The model then generates the relevant prediction outputs 325, which includes a predicted delay time 365 like 56 milliseconds (for a regression model), a predicted access delay label 375 like “High” (for a classification model) (if the set threshold for classification is 50 milliseconds), or a combination thereof. Based on the prediction, the model may infer patterns. For example, as the RSSI threshold 330 approaches −75 dBm, the access delay tends to decrease, indicating improved network efficiency. However, when the RSSI threshold exceeds −75 dBm leads access delay increases, possibly due to reduced effectiveness in CG formation and coordination. This trend suggests there is an optimal (or at least optimized) point for the RSSI threshold. In the illustrated example, the model may determine that an RSSI threshold of −75 dBm is optimal (or at least optimized) that balances the need for sufficient signal strength for effective CG formation with the need to minimize access delay.

Although the model training component 310 and the prediction component 315 are depicted as discrete components for conceptual clarity, in some embodiments, the operations of the depicted components (and others not depicted) may be combined or distributed across any number and variety of components, and may be implemented using hardware, software, or a combination of hardware and software.

In some embodiments, the optimal (or at least improved) RSSI threshold determined by the trained ML model may then be integrated into the RL model (e.g., 200 of FIG. 2). With the refined threshold setting, the RL model may select the proper number of CGs to join, which leads to more effective coordination and communication within the network.

In the illustrated example workflow, the training dataset 305 includes three variables as input features for supervised ML training. The training dataset 305 is provided for conceptual clarity. In some embodiments, a broader range of network performance metrics and/or environmental factors may be incorporated as input features for predicting access delay, which may include variables such as channel utilization (CU), interference levels, or specific traffic patterns within the network. Additionally, although in the illustrated example the access delay serves as an indicator of the RL agent's (AP 1) performance, other embodiments may use different performance metrics as target outputs to measure the agent's performance. For example, in some embodiments, the total network resources allocated to the agent (AP 1), such as the overall bandwidth, the total timeslots, or the total number of TXOPs or RUs assigned, may be used as alternative measures of performance. More details and examples of the alternative metric can be found with reference to FIG. 4.

FIG. 4 depicts an example workflow 400 for supervised machine learning (ML) training and prediction, using total timeslots as labels, according to some embodiments of the present disclosure.

In the illustrated example, the total allocated network resources, such as the total timeslots (in milliseconds) allocated to the RL agent (AP 1), are used as measures for network performance and efficiency. The ML model is trained to predict the total allocated timeslots based on the RSSI thresholds. The training dataset 405, as illustrated, includes variables like the RSSI threshold 430, number of CGs 435, APs involved 440, and measured total timeslots 455. As discussed above, in some embodiments, the RSSI threshold 430 may refer to the signal strength threshold set by the RL model (e.g., 200 of FIG. 2), indicating the minimum acceptable signal quality for AP 1 to join a CG. The number of CGs 435 may refer to the total number of CGs that the agent (AP 1) joined. The APs involved 440 may detail the specific APs that are members of the CGs AP 1 joined. The measured total timeslots 445 may represent the total duration (in milliseconds) of TXOPs or RUs allocated to AP 1 for data transmission over a certain period of time. This metric measures how much airtime AP 1 is granted for sending data to its associated STAs (e.g., 150, 155 of FIG. 1), which provides a direct indicator of the network's capacity to support data traffic.

The training dataset 405 reflects the relationship between different RSSI thresholds, their impact on CG formation, and the subsequent allocation of network resources to AP 1. Each entry in the dataset 405 represents an individual data sample 470, and the values in each data sample 470 are collected during the execution of the RL model at a specific RSSI threshold setting. For example, the first data sample 470-1 in the training dataset 405 indicates that the RSSI threshold is set to −85 dBm. Under this setting, the RL model leads AP 1 (the agent) to join 7 CGs, with the APs involved in these CGs including AP 2, AP 3 and AP 4 (as depicted in FIG. 1). When AP 1 initiates data transmission to one of its associated STAs (e.g., 150, 155 of FIG. 1), it must coordinate with these APs for efficiently utilizing the available network resources. A measured total timeslot of 200 ms is recorded, suggesting that AP 1 is allocated a relatively shorter duration for data transmission, possibly due to the high number of CGs it is part of.

As illustrated, the second data sample 470-2 shows that at an RSSI threshold 430 of −75 dBm, AP 1 joins 3 CGs involving AP 2 and AP 3 (as depicted in FIG. 1). In this configuration, the total timeslots allocated to AP 1 increase to 350 ms, indicating that AP 1 has more time for data transmission. This may be due to the reduced complexity of coordinating with fewer CGs, which leads to more efficient resource allocation.

In the third data sample 470-3, with the RSSI threshold 430 increasing to −65 dBm, AP 1 is part of only one CG, which includes AP 2 (as depicted in FIG. 1). In this configuration, the total timeslots allocated to AP 1 decrease to 250 ms, compared with 350 ms in the second data sample. The reduction in allocated timeslots may suggest that being a single CG results in AP 1 losing opportunities for optimal network resource allocation. Although being a part of a single CG may simplify network coordination, it may also limit AP 1's access to a broader range of TXOPs available in situations with multiple CGs.

The fourth data sample 470-4 at an RSSI threshold of −50 dBm shows AP not joining any CGs, with no other APs involved. The total timeslots allocated to AP 1 reduce to 215 ms. The reduction may be caused by increased contention or a lack of coordinated management, which results in less optimal resource allocation for AP 1 in the absence of any CG participation.

In the illustrated example, the training dataset 405, which captures the data patterns between different RSSI thresholds, CG formations, and the total timeslot allocations, is then provided to model training component 410. Within the component 410, a model is trained to predict the total timeslots allocated to AP 1 based on an established RSSI threshold (which is one hyperparameter defined in the RL model). In the supervised training process, the first three variables in the dataset 405, RSSI threshold 430, number of CGs 435, and the APs involved 440, are used as input features, and the variable of measured total timeslots 455 is used as the target output.

In some embodiments, once the model training is complete, a testing dataset 460 may be applied to evaluate the accuracy and effectiveness of the trained model. The testing dataset 460, including unseen and labeled data samples, may be used to assess how well the model generalizes to new data that it has not met during training.

Following the training and/or testing, the model is then integrated into the prediction component 415 for inference. During the inference phase, new input data 420 is provided to the model, which includes variables such as the RSSI threshold 430. As illustrated, the new input data shows the RSSI threshold 430 at −85 dBm. The model, upon receiving the input 420, generates the relevant prediction outputs 425, which indicates the total timeslots 465 that will be assigned to AP 1 is 280 ms. Based on the prediction for various RSSI thresholds, the model may infer data patterns and trends. For example, if the prediction reveals that increasing an RSSI threshold to −75 dBm results in AP 1 obtaining more timeslots, and further increasing the RSSI threshold beyond-75 dBm leads to a decrease in total timeslots, the model may identify a pattern in the relationship between RSSI thresholds and resource allocations. From these inferences, the model may determine that −75 dBm is an optimal (or at least optimized) RSSI threshold. This threshold considers the need for strong enough signals to form effective CGs, while also maximizing the allocation of total timeslots to AP 1.

In some embodiments, the optimal (or at least optimized) RSSI threshold determined by the trained ML model may then be integrated into the RL model (e.g., 200 of FIG. 2). For example, in this illustrated configuration, the RSSI threshold within the RL model may be adjusted to −75 dBm. The RL model, updated with the new threshold setting, may effectively determine the proper CGs that AP 1 can join for efficient network coordination. The refined threshold level ensures that AP 1 joins an appropriate number of CGs, avoiding joining too many that may burden the network with excessive coordination overhead, and preventing joining too few, which may lead to missed opportunities for effective resource utilization and spatial reuse.

Although the model training component 410 and the prediction component 415 are depicted as discrete components for conceptual clarity, in some embodiments, the operations of the depicted components (and others not depicted) may be combined or distributed across any number and variety of components, and may be implemented using hardware, software, or a combination of hardware and software.

In the illustrated example workflow 400, the training dataset 405 includes three variables as input features for supervised ML training. The training dataset 405 is provided for conceptual clarity. In some embodiments, a broader range of network performance metrics and environmental factors may be incorporated as input features for predicting the total timeslots allocated to the agent (AP 1), which may include variables such as channel utilization, interference levels, or specific traffic patterns within the network.

The example workflows 300 and 400 depicted in FIGS. 3 and 4 relate to training ML models to identify an optimal (or at least improved) RSSI threshold, which is one of the hyperparameters within the RL model (e.g., 200 of FIG. 2). These depicted workflows are provided for conceptual clarity and to illustrate the process of integrating machine learning techniques into reinforcement learning models. In some embodiments, other optimal (or at least improved) hyperparameters may be determined by trained ML models, including, but not limited to, the maximum number of CGs that the agent (AP 1) can join, specific CGs that the agent should avoid (e.g., due to factors like high interference or low signal strength), the frequency of joining or opting out of CGs. and a SNR threshold for CG participation.

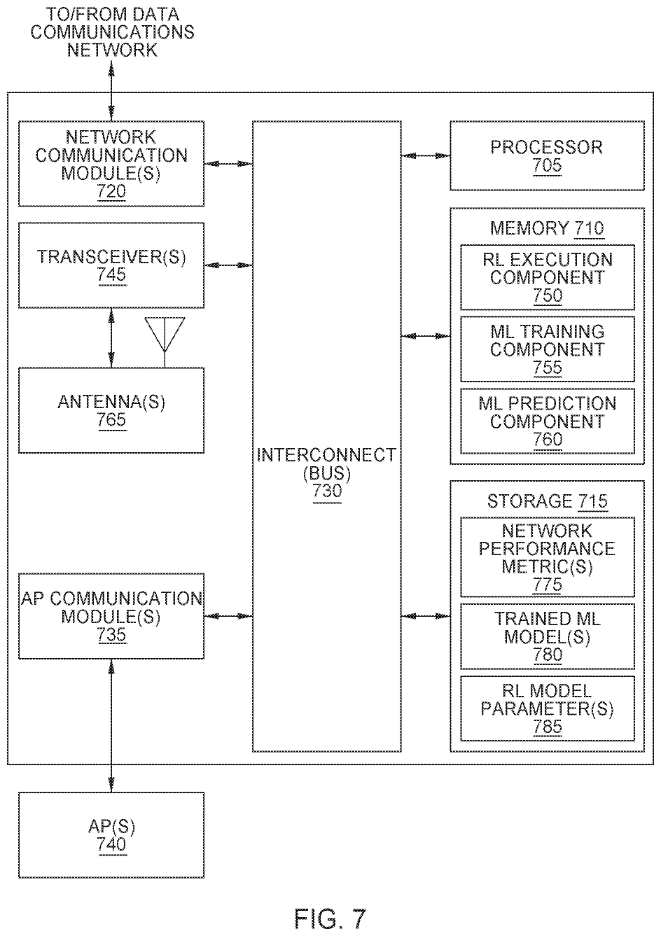

In some embodiments, the workflows 300 and/or 400 may be performed by one or more computing systems or devices, such as the computing device 700 depicted in FIG. 7. The computing device may be an edge computing device that has more computing power that conventional APs. The computing device may connect to one or more APs (e.g., AP 1, AP 2, AP 3, and AP 4 of FIG. 1) via wired or wireless connections, and be configured to handle the computationally intensive operations, such as running the RL and ML models, processing and analyzing network performance data, and determining optimal (or at least optimized) hyperparameters (e.g., RSSI threshold). Upon determining the optimal (or at least optimized) CGs for an AP (e.g., AP 1) to join, the computing device may communicate the information to the corresponding AP (e.g., AP 1), guiding the AP for effective CG formation.

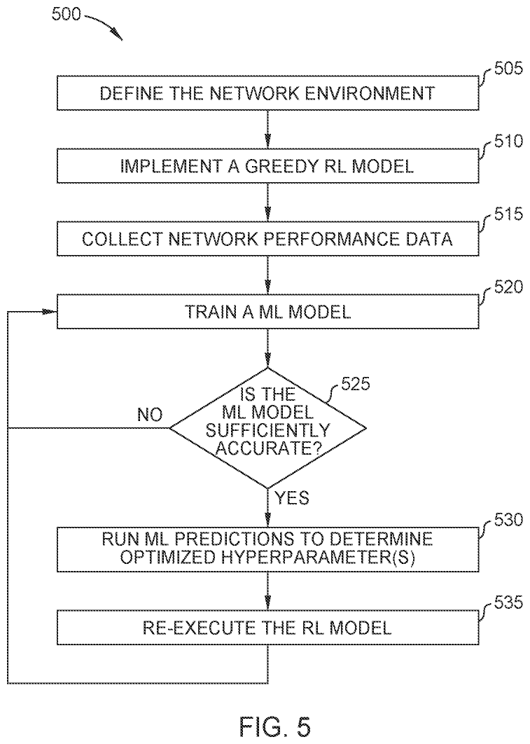

FIG. 5 depicts an example method 500 for optimizing coordination group (CG) formation in multi-AP networks using machine learning (ML) models, according to some embodiments of the present disclosure. In some embodiments, the method 500 may be performed by one or more computing systems or devices, such as the computing device 700 depicted in FIG. 7.

At block 505, a computing device (e.g., 700 of FIG. 7) defines a network environment (e.g., 100 of FIG. 1), which includes multiple APs (e.g., AP 1, AP 2, AP 3, and AP 4 of FIG. 1).

In some embodiments, the computing device may perform network topology mapping, which involves identifying the location of each AP, its coverage area, and the potential overlap between different coverage areas. In some embodiments, the APs (e.g., AP 1, AP 2, AP 3, and AP 4 of FIG. 1) may report their own location and coverage metrics to the computing device. In some embodiments, the computing device may actively listen to beacon frames from the APs or probe requests/responses between the APs and their clients. By analyzing signal strength and quality from various APs at different points in the network, the computing device may infer the approximate coverage area of each AP.

In some embodiments, based on the network topology and the characteristics of the APs, the computing device may identify potential CGs that can be formed within the network environments. For example, in an environment with four APs, such as the environment 100 depicted in FIG. 1, the computing device may determine that up to seven possible CGs can be formed involving AP 1, including CGs where AP 1 coordinates with each of these APs individually (e.g., CG 1 including AP 1 and AP 2, CG 2 including AP 1 and AP 3, CG 3 including AP 1 and AP 4, as depicted in FIG. 2), as well as various combination of them (e.g., CG 4 including AP 1, AP 2, and AP 3, CG 5 including AP 1, AP 2 and AP 4, CG 6 including AP 1, AP 3 and AP 4, and CG 7 including AP 1, AP 2, AP 3, and AP 4, as depicted in FIG. 2).

At block 510, the computing device implements a RL model (e.g., 200 of FIG. 2) with a greedy policy. The RL is designed to enable an agent AP (e.g., AP 1 of FIG. 2) to experiment with joining all potential CGs within a short time frame (either within a single TXOP or across several TXOPs). The greedy aspect of the RL model refers to its focus on immediate rewards. In some embodiments, the RL model may enable the agent AP to join every CG with which it has sufficient signal strength (e.g., RSSI, SNR), and/or volunteer to be the leader (through which the agent AP can obtain the first timeslot of a future TXOP). The greedy approach is used for maximizing the network resources that the agent AP can obtain.

As the RL model operates, at block 515, the computing device may learn the benefits of joining some CGs by monitoring and collecting various metrics reflecting the agent AP's network performance. These metrics may include access delay (e.g., in milliseconds), the total number of TXOPs or the total timeslots obtained for data transmission (e.g., in milliseconds), and the like. For example, when the RL operates with an RSSI threshold set at −85 dBm, all seven potential CGs pass the threshold. This indicates that the signal strength between the agent AP (e.g., AP 1 of FIG. 1) and the members of these CGs (e.g., including AP 2, AP 2, AP 3, and their associated STAs, as depicted in FIG. 1) is sufficient strong for effective communication and coordination. Under such a configuration, the detected access delay may be recorded as 60 ms, with total assigned timeslots amounting to 200 ms (as depicted in FIGS. 3 and 4).

At block 520, the computing device utilizes the collected data (e.g., 305 of FIG. 3, 405 of FIG. 4) to train ML models. In some embodiments, the data may include a broad range of information about the network's performance under various conditions as determined by the RL model, such as signal strength, the number of CGs the agent AP joined, access delays, and the total timeslots allocated for data transmission. In some embodiments, the ML model may be trained to understand how various decisions made by the RL model regarding CG participation affect the network's performance and efficiency. These decisions are governed by some hyperparameters in the RL model, such as the RSSI/SNR threshold for CG formation, the maximum number of CGs that the agent AP can join, the frequency of joining or opting out of CGs, and the specific CGs to avoid (e.g., due to factors like high interference or low signal strength). By analyzing historical data collected during the RL model's operation, the ML model may identify patterns and correlations between these hyperparameters and performance metrics. For example, the ML model may be trained to identify the correlation between different RSSI thresholds and resulting network performance metrics like access delays or the total timeslots allocated for data transmission (as depicted in FIGS. 3 and 4). Through the training, the ML model may predict the outcomes of adjusting these hyperparameters (e.g., the RSSI threshold) on network performance. For example, the RL model may predict the access delays associated with different RSSI threshold levels, and subsequently identify the RSSI threshold (e.g., −75 dBm as depicted in FIG. 3) that results in the lowest (or at least reduced) access delay (e.g., 50 ms as depicted in FIG. 3). The identified RSSI level may represent an optimal (or at least optimized) balance between signal strength and network efficiency.

At block 525, the computing device evaluates the trained ML model's performance. In some embodiments, the evaluation process may include testing the model using a separate dataset (also referred to in some embodiments as a testing dataset) (e.g., 360 and 460 of FIGS. 3 and 4), which consists of unseen and labeled data, different from the one used for training (e.g., 305 and 405 of FIGS. 3 and 4). Various metrics may be used to assess the model's performance, including but not limited to accuracy, precision, recall, and F1-score. If the ML model demonstrates a high level of accuracy and/or effectiveness in the testing phase (like passing a defined threshold for precision), it indicates the model is ready for practical application, such as predicting network performance outcomes based on different RL model parameters. However, if the model's performance does not meet the desired standards (like falling below a defined threshold for precision), it indicates the model requires further refinements, and the method 500 returns to block 520.

At block 530, the computing device executes the trained ML model to determine optimized hyperparameters that further refine the RL model's decision-making process. For example, in some embodiments, the ML model may be used to predict the access delays experienced by the agent AP (AP 1) under different RSSI threshold settings, including those that were not previously detected or considered during the RL model's execution. Through the prediction, the ML may identify the RSSI threshold that results in the lowest (or at least reduced) access delay. The identified RSSI threshold may represent an optimal (or at least improved) balance between ensuring strong signal connectivity for CG formation and minimizing delays in data transmission.

At block 535, with the optimized hyperparameters obtained from the ML model, the RL model (e.g., 200 of FIG. 2) is updated and re-executed. The reimplementation allows the RL model to make more informed decisions on CG formations, and therefore facilitates more efficient network communication and coordination.

Following the reimplementation of the RL model, additional performance data may be collected, including updated metrics such as access delays or total timeslots allocated under the new RL model settings. The method 500 returns back to block 520, where the computing device provides the newly collected data into the ML model for further refinement and adjustment. The iterative process for continuous learning ensures that the model's predictions and recommendations are adapted based on the latest operational data.

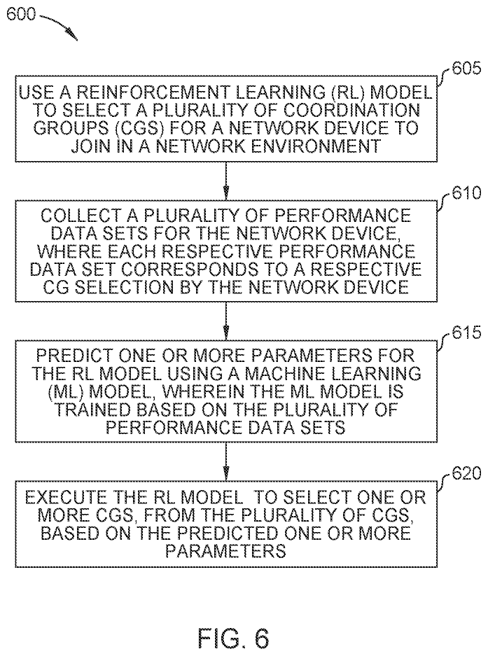

FIG. 6 is a flow diagram depicting an ML-driven method 600 for multi-AP coordination group (MAPC-CG) formation and optimization, according to some embodiments of the present disclosure.

At block 605, a computing device (e.g., 700 of FIG. 7) uses a reinforcement learning (RL) model (e.g., 200 of FIG. 2) to select a plurality of Coordination Groups (CGs) for a network device (e.g., AP 1 of FIG. 1) to join in a network environment (e.g., 100 of FIG. 1).

At block 610, the computing device collects a plurality of performance data sets for the network device (e.g., AP 1 of FIG. 1), where each respective performance data set corresponds to a respective CG selection by the network device. In some embodiments, the each respective performance data set for the network device may comprise at least one of: (i) an Received Signal Strength Indicator (RSSI) value; (ii) a Signal-to-Noise Ratio (SNR) value; (iii) a channel utilization rate; (iv) an access delay; or (v) a timeslot allocated to the network device.

At block 615, the computing device predicts one or more parameters for the RL model using a machine learning (ML) model, where the ML model is trained based on the plurality of performance data sets. In some embodiments, the predicted one or more parameters for the RL model may comprise at least one of: (i) a maximum number of CGs the network device can join; (ii) one or more CGs to avoid based on historical performance data; (iii) a frequency of joining or opting out of CGs; (iv) an RSSI threshold for joining a CG; or (v) a SNR threshold for joining a CG.

At block 620, the computing device executes the RL model to select one or more CGs, from the plurality of CGs, based on the predicted one or more parameters.

In some embodiments, the process of using the RL model to select the plurality of CGs for the network device to join in the network environment may comprise measuring signal strength data between the network device and each respective network device within a first CG, of the plurality of CGs, and upon determining the signal strength data exceeds a defined threshold, providing a positive reward for joining the first CG, of the plurality of CGs, to the RL model. In some embodiments, the signal strength data may comprise at least one of a RSSI value or a SNR value.

In some embodiments, the computing device may train the ML model using an RSSI value as an input feature, and an access delay as a target output, where the ML model learns to correlate the RSSI value to the access delay.

In some embodiments, the computing device may train the ML model using an RSSI value as an input feature, and a timeslot allocated to the network device for each CG selection as a target output, where the ML model learns to correlate the RSSI values to the timeslot.

FIG. 7 depicts an example computing device 700 configured to perform various aspects of the present disclosure, according to one embodiment. In some embodiments, the computing device 700 may correspond to an AP, such as the AP 1, AP 2, AP 3, and AP 4, as depicted in FIG. 1. In some embodiments, the computing device 700 may correspond to an edge computing unit that communicates with the APs through wired and/or wireless links.

As illustrated, the computing device 700 includes a processor 705, memory 710, storage 715, one or more transceivers 765, one or more AP communication modules 735, and one or more network communication modules 720. Each of the components is communicatively coupled by one or more buses 730. In some embodiments, one or more antennas may be coupled to the transceivers 765 for transmitting and receiving wireless signals.

The memory 710 may include random access memory (RAM) and read-only memory (ROM). The memory 710 may store processor-executable software code containing instructions that, when executed by the processor 705, enable the device 700 to perform various functions described herein for wireless communication. In the illustrated example, the memory 710 includes three software components: the RL execution component 750, the ML training component 755, and the ML prediction component 760. In some embodiments, the RL execution component 750 may be configured to implement and run a greedy RL model that makes decisions about CG participation based on the current network conditions. As the RL model operates, the RL execution component 750 may evaluate the possible CGs for an agent AP to join, based on factors like signal strength or network congestion. In some embodiments, the ML training component 755 may be designed for processing the performance data collected from the network during the execution of the RL model, and using it to train a supervised ML model. The performance metrics may be collected for different CG selections, and may include a variety of metrics, such as signal strength values, access delays, resource allocations, and channel utilizations, among others. The model may be trained to learn patterns and relationships that can predict optimal (or at least optimized) configurations (or hyperparameters) of the RL model. In some embodiments, the ML prediction component 760 may be configured to implement the trained ML model to make predictions about network performance under various configurations (or hyperparameters) of the RL model. For example, the ML prediction component 760 may predict outcomes like access delays and/or network resource allocations associated with different RSSI thresholds (established for CG formations within the RL model), and subsequently identify the RSSI threshold that results in optimal (or at least improved) network performance.

The processor 705 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 705 processes information received through the transceiver 765, the AP communication module 735, and the network communication module 720. The processor 705 retrieves and executes programming instructions stored in memory 710, as well as stores and retrieves application data residing in storage 715. In some embodiments, the processor 705 may be configured to perform various computationally intensive operations, including, but not limited to, executing the RL model, training the ML models based on collected network performance data, implementing the trained ML models to predict optimal (or at least optimized) configurations of the RL model, and reexecuting the RL model for optimized CG formation. Upon the optimized CGs formation is determined, the information may then be forwarded to the AP communication module 260 for implementation and communication. The AP communication module 260 may generate instructions to adjust the operations of APs 740 (e.g., AP 1 of FIG. 1) within the network environment, including joining or leaving specific CGs, adjusting transmission parameters, or coordinating more closely with certain BSSs to enhance network efficiency and performance. In some embodiments, for networks where APs are within wireless range of the computing device 700, the instructions may be transmitted wirelessly using the transceiver 765. In embodiments where APs are connected to the computing device 700 through wired connections, these physical links may be used to transmit the instructions.

The storage 715 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 715 may store a variety of data for efficient functioning of the system. The data may include network performance metric(s) 775 (e.g., signal strength, CU, access delay, and the total timeslots allocated for data transmission), trained ML model(s) 780, and predicted parameter(s) and/or configuration(s) of the RL model.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method comprising:
using a reinforcement learning (RL) model to select a plurality of Coordination Groups (CGs) for a network device to join in a network environment;
collecting a plurality of performance data sets for the network device, wherein each respective performance data set corresponds to a respective CG selection by the network device;
predicting one or more parameters for the RL model using a machine learning (ML) model, wherein the ML model is trained based on the plurality of performance data sets; and
executing the RL model to select one or more CGs, from the plurality of CGs, based on the predicted one or more parameters.

2. The method of claim 1, wherein the each respective performance data set for the network device comprises at least one of: (i) an Received Signal Strength Indicator (RSSI) value; (ii) a Signal-to-Noise Ratio (SNR) value; (iii) a channel utilization; (iv) an access delay; or (v) a timeslot allocated to the network device.

3. The method of claim 1, wherein the predicted one or more parameters for the RL model comprise at least one of: (i) a maximum number of CGs the network device can join; (ii) one or more CGs to avoid based on historical performance data; (iii) a frequency of joining or opting out of CGs; (iv) an RSSI threshold for joining a CG; or (v) a SNR threshold for joining a CG.

4. The method of claim 1, wherein using the RL model to select the plurality of CGs for the network device to join in the network environment, comprises:
measuring signal strength data between the network device and each respective network device within a first CG, of the plurality of CGs; and
upon determining the signal strength data exceeds a defined threshold, providing a positive reward for joining the first CG, of the plurality of CGs, to the RL model.

5. The method of claim 4, wherein the signal strength data comprises at least one of an RSSI value or a SNR value.

6. The method of claim 1, further comprising training the ML model using an RSSI value as an input feature, and an access delay as a target output, wherein the ML model learns to correlate the RSSI value to the access delay.

7. The method of claim 1, further comprising training the ML model using an RSSI value as an input feature, and a timeslot allocated to the network device for each CG selection as a target output, wherein the ML model learns to correlate the RSSI values to the timeslot.

8. A system comprising:
one or more computer processors; and
one or more memories collectively containing one or more programs, which, when executed by the one or more computer processors, perform operations, the operations comprising:
using a reinforcement learning (RL) model to select a plurality of Coordination Groups (CGs) for a network device to join in a network environment;
collecting a plurality of performance data sets for the network device, wherein each respective performance data set corresponds to a respective CG selection by the network device;
predicting one or more parameters for the RL model using a machine learning (ML) model, wherein the ML model is trained based on the plurality of performance data sets; and
executing the RL model to select one or more CGs, from the plurality of CGs, based on the predicted one or more parameters.

9. The system of claim 8, wherein the each respective performance data set for the network device comprises at least one of: (i) an Received Signal Strength Indicator (RSSI) value; (ii) a Signal-to-Noise Ratio (SNR) value; (iii) a channel utilization rate; (iv) an access delay; or (v) a timeslot allocated to the network device.

10. The system of claim 8, wherein the predicted one or more parameters for the RL model comprise at least one of: (i) a maximum number of CGs the network device can join; (ii) one or more CGs to avoid based on historical performance data; (iii) a frequency of joining or opting out of CGs; (iv) an RSSI threshold for joining a CG; or (v) a SNR threshold for joining a CG.

11. The system of claim 8, wherein, to use the RL model to select the plurality of CGs for the network device to join in the network environment, the one or more programs, which, when executed by the one or more computer processors, perform the operations comprising:
measuring signal strength data between the network device and each respective network device within a first CG, of the plurality of CGs; and
upon determining the signal strength data exceeds a defined threshold, providing a positive reward for joining the first CG, of the plurality of CGs, to the RL model.

12. The system of claim 11, wherein the signal strength data comprises at least one of an RSSI value or a SNR value.

13. The system of claim 8, wherein the one or more programs, which, when executed on any combination of the one or more computer processors, perform the operations further comprising training the ML model using an RSSI value as an input feature, and an access delay as a target output, wherein the ML model learns to correlate the RSSI value to the access delay.

14. The system of claim 8, wherein the one or more programs, which, when executed on any combination of the one or more computer processors, perform the operations further comprising training the ML model using an RSSI value as an input feature, and a timeslot allocated to the network device for each CG selection as a target output, wherein the ML model learns to correlate the RSSI values to the timeslot.

15. One or more non-transitory computer-readable media containing, in any combination, computer program code, which, when executed by a computer system, performs operations comprising:
using a reinforcement learning (RL) model to select a plurality of Coordination Groups (CGs) for a network device to join in a network environment;
collecting a plurality of performance data sets for the network device, wherein each respective performance data set corresponds to a respective CG selection by the network device;
predicting one or more parameters for the RL model using a machine learning (ML) model, wherein the ML model is trained based on the plurality of performance data sets; and
executing the RL model to select one or more CGs, from the plurality of CGs, based on the predicted one or more parameters.

16. The one or more non-transitory computer-readable media of claim 15, wherein the each respective performance data set for the network device comprises at least one of: (i) an Received Signal Strength Indicator (RSSI) value; (ii) a Signal-to-Noise Ratio (SNR) value; (iii) a channel utilization rate; (iv) an access delay; or (v) a timeslot allocated to the network device.

17. The one or more non-transitory computer-readable media of claim 15, wherein the predicted one or more parameters for the RL model comprises at least one of: (i) a maximum number of CGs the network device can join; (ii) one or more CGs to avoid based on historical performance data; (iii) a frequency of joining or opting out of CGs; (iv) an RSSI threshold for joining a CG; or (v) a SNR threshold for joining a CG.

18. The one or more non-transitory computer-readable media of claim 15, wherein, to use the RL model to select the plurality of CGs for the network device to join in the network environment, the computer program code, which, when executed by the computer system, performs the operations comprising:
measuring signal strength data between the network device and each respective network device within a first CG, of the plurality of CGs; and
upon determining the signal strength data exceeds a defined threshold, providing a positive reward for joining the first CG, of the plurality of CGs, to the RL model.

19. The one or more non-transitory computer-readable media of claim 15, wherein the computer program code, which, when executed by a computer system, performs the operations further comprising training the ML model using an RSSI value as an input feature, and an access delay as a target output, wherein the ML model learns to correlate the RSSI value to the access delay.

20. The one or more non-transitory computer-readable media of claim 15, wherein the computer program code, which, when executed by a computer system, performs the operations further comprising training the ML model using an RSSI value as an input feature, and a timeslot allocated to the network device for each CG selection as a target output, wherein the ML model learns to correlate the RSSI values to the timeslot.
